(19) United States
(12) Patent Application Publication
(10) Pub. No.: US 2003/0228089 A1
(43) Pub. Date: Dec. 11, 2003

(54) Method of controlling the curvature of an optical device

(76) Inventor: Scott Blackstone, Alton, NH (US)

Correspondence Address: BROMBERG & SUNSTEIN LLP, 125 SUMMER STREET, BOSTON, MA, 02110-1618, US

(21) Appl. No.: 10/201,215

(22) Filed: Jul. 23, 2002

Related U.S. Application Data
(60) Provisional application No. 60/387,643, filed on Jun. 11, 2002.

(51) Int. Cl. G02B 6/26; G02B 6/42

(52) U.S. Cl. 385/18

(57) ABSTRACT

A method of controlling the curvature of an optical device applies a material that affects the molecular structure of the optical device. To that end, a material having at least one predetermined property is selected, and then applied into the optical device. Application of the material causes stress in the optical device. The curvature of the optical device thus changes after the material is applied. As noted above, the material affects the molecular structure of the optical device.

### FIELD OF THE INVENTION

The invention relates generally to optical devices and, more particularly, the invention relates to controlling the curvature of an optical networking device that either or both reflects and transmits light.

### BACKGROUND OF THE INVENTION

Optical networks are becoming the data transmission medium of choice in the networking field. Among other advantages, optical networks generally have a higher bandwidth and lower power/line loss. To that end, optical fibers carrying data typically connect with an optical switching device that reflects incoming light signals between fibers. More specifically, optical switching devices typically have one or more internal mirrors that reflect light beams between optical fibers.

To accurately reflect light beams between different optical fibers, each mirror must have a well controlled radius of curvature. Data can be lost by misdirected and/or dispersed light beams if the curvature is off by a relatively small amount. Accordingly, one currently used technique to control the radius of curvature of a mirror applies a film, with a known coefficient of thermal expansion, to a silicon mirror base. Since the coefficients of thermal expansion are known for both the film and the silicon mirror base, the radius of curvature can be controlled to some extent by selecting the appropriate material as a film, and manipulating other design parameters.

Although sufficient in some instances, it would be advantageous to more accurately control the radius of curvature of optical mirrors. It also would be advantageous to permit use of films that do not have the coefficients of thermal expansion required to achieve the correct radius of curvature.

### SUMMARY OF THE INVENTION

In accordance with one aspect of the invention, a method of controlling the curvature of an optical device applies a material that affects the molecular structure of the optical device. To that end, a material having at least one predetermined property is selected, and then applied into the optical device. Application of the material causes stress in the optical device. The curvature of the optical device thus changes after the material is applied. As noted above, the material affects the molecular structure of the optical device.

The optical device may be at least one of a mirror and a lens. In some embodiments, the optical device includes a surface to receive the application, where the material is applied to less than the entire area of that surface. The material is comprised of molecules having a size. The stress in the optical device thus is a function of the size of the molecules of the material. In addition, the optical device may include silicon.

The optical device may include a surface to which a reflective layer is applied. In addition, the optical device may be heated to further affect the molecular structure of the optical device. By way of example and not limitation, the material may be one of phosphorous, boron, arsenic, germanium, carbon, indium, and aluminum. In some embodiments, the material is applied via at least one of a diffusion process and an implantation process.

In accordance with another aspect of the invention, a method of setting the curvature of a light distorting portion of an optical device to a given curvature selects a material having at least one predetermined property, and provides the light distorting portion. The method also applies the material to the light distorting portion based upon at least one predetermined property of the material. The curvature of the light distorting portion changes to the given curvature after the material is applied. In illustrative embodiments, the material affects the molecular structure of the light distorting portion.

Among other things, the light distorting portion may be at least one of a silicon lens of a MEMS device and a silicon mirror of a MEMS device. In illustrative embodiments, the material is a charged material that interacts with the light distorting portion to cause the curvature of the light distorting portion to change from its unapplied state. The method further may heat the light distorting portion after the material is applied.

In accordance with other aspects of the invention, a method of manufacturing a reflective mirror of an optical device shapes the reflective mirror to a given curvature. To that end, the method provides a substantially flat silicon mirror base, and selects a material having at least one predetermined property. In addition, the method applies the material to the mirror base as a function of at least one property of the material. The curvature of the mirror base changes to the given curvature after the material is applied. The material affects the molecular structure of the light distorting portion. The method continues by adding a reflective layer to one surface of the mirror base.

The mirror may be heated after the material is applied. In some embodiments, the reflective layer is added after the mirror base is heated. In other embodiments, the reflective layer is added before the mirror base is heated.

### BRIEF DESCRIPTION OF THE DRAWINGS

The foregoing and advantages of the invention will be appreciated more fully from the following further description thereof with reference to the accompanying drawings wherein:

FIG. 1 schematically shows an exemplary network that may be used with illustrative embodiments of the invention.

FIG. 2 schematically shows an exemplary optical switch that may use mirrors produced in accordance with illustrative embodiments of the invention.

FIG. 3 shows a process of producing a mirror in accordance with illustrative embodiments of the invention.

FIG. 4A schematically shows an exemplary material as it is initially applied to a silicon base in a first manner.

FIG. 4B schematically shows the silicon base of FIG. 4A after the material is applied.

FIG. 5A schematically shows an exemplary material as it is initially applied to a silicon base in a second manner.

FIG. 5B schematically shows the silicon base of FIG. 5A after the material is applied.

FIG. 6 shows a process of producing a lens in accordance with illustrative embodiments of the invention.

### DESCRIPTION OF ILLUSTRATIVE EMBODIMENTS

In illustrative embodiments of the invention, a silicon mirror or lens is produced by applying a material directly into the crystal lattice so that it bows in a controlled manner. By using this technique, a mirror or lens may be precisely shaped to more effectively control a beam of light within an optical device, such as an optical micro-electromechanical system (“MEMS”). Details are discussed below.

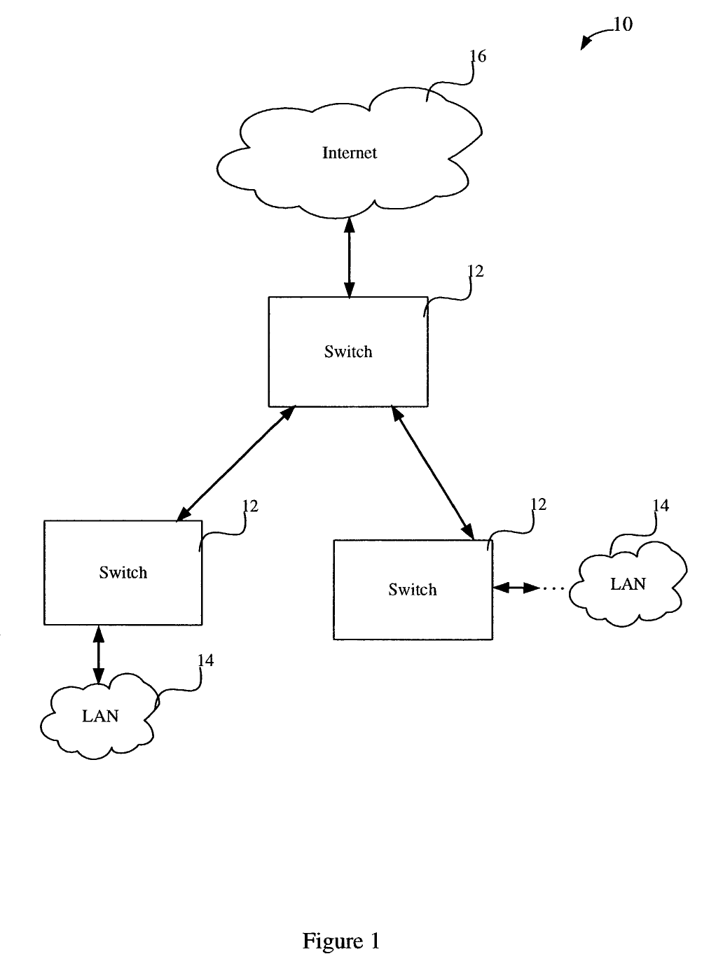

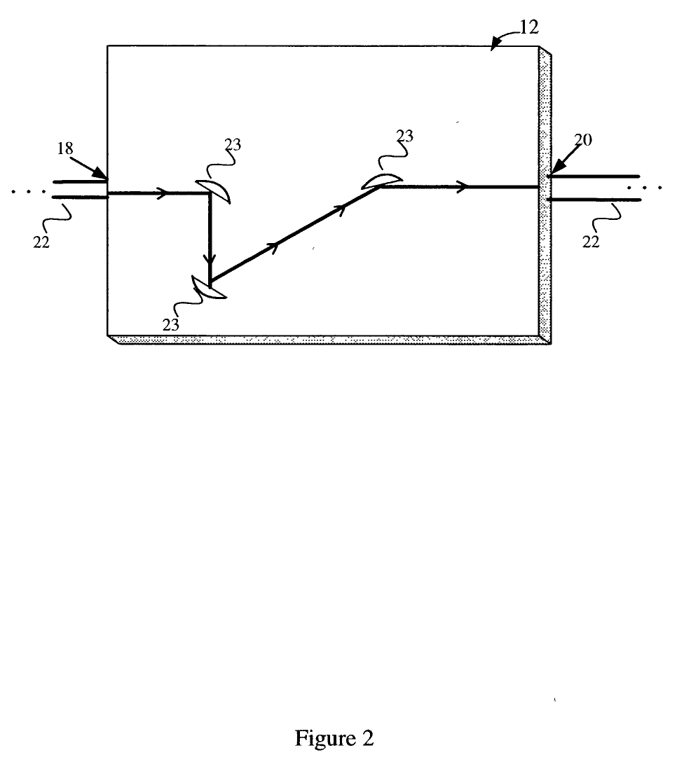

FIG. 1 schematically shows an exemplary network 10 that may use optical switches 12 having mirrors or lenses (FIG. 2) produced in accordance with illustrative embodiments of the invention. The network 10 includes three switches 12 that connect between two local area networks 14 and the Internet 16. At least one of the switches 12 includes mirrors or lenses for redirecting light beams received over a fiber optic cable. It should be noted, however, that discussion of the network configuration shown in FIG. 1 is exemplary and not intended to limit the scope of the invention. Accordingly, other network configurations at least in part using light transmission media may be used.

FIG. 2 schematically shows an exemplary switch 12 that may be used in the network 10 of FIG. 1. The switch 12 includes an input port 18 for receiving a light beam via a fiber optic cable 22, and an output port 20 for transmitting the light beam via another fiber optic cable 22. Although multiple fiber optic cables 22 may be coupled with the switch 12 via multiple ports, only a single input and output port 18 and 20 are shown for simplicity. The switch 12 also includes three mirrors 23 to reflect the incoming light beam from the input to the output. In illustrative embodiments, the switch 12 is a micro-electromechanical system (“MEMS”). Of course, various embodiments are not limited to switches. Other network devices or light processing devices that use a mirror and/or a lens may incorporate illustrative embodiments of the invention.

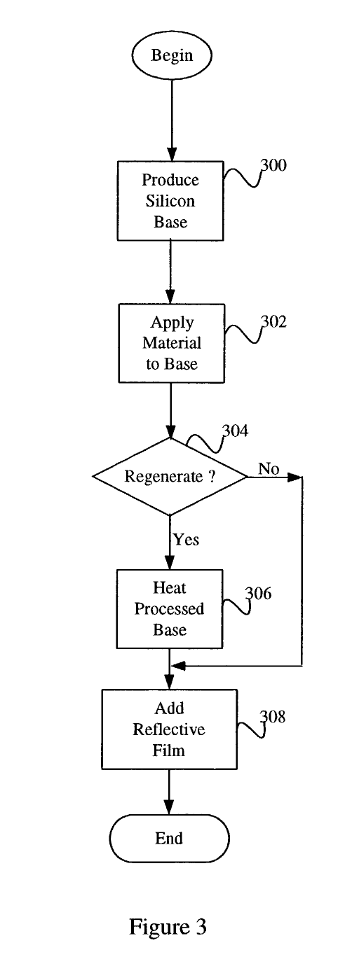

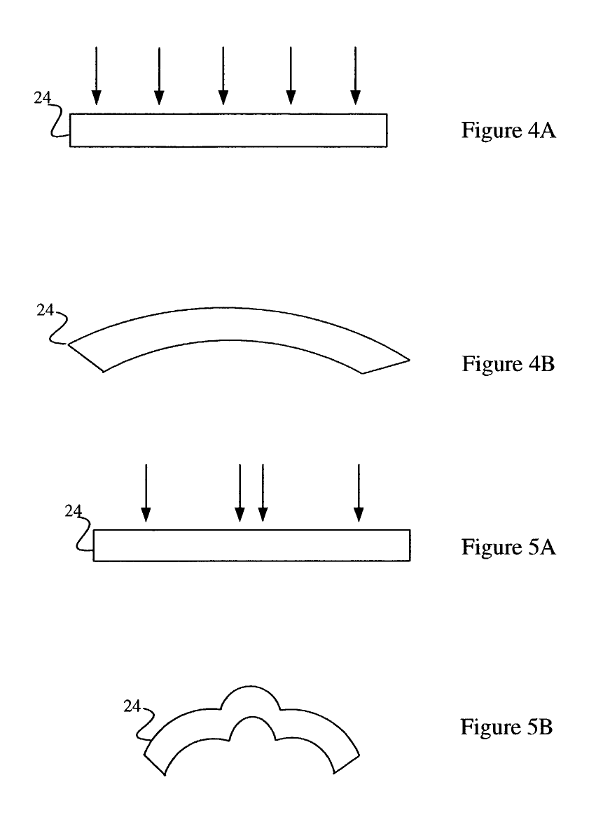

As suggested above, illustrative embodiments may be applied to either a lens or a mirror 23. FIG. 3 shows a process of producing a mirror 23 in accordance with various embodiments of the invention the process begins at step 300, in which a silicon base (shown in FIGS. 4A, 4B, 5A, and 5B, and identified by reference number 24) is produced. To that end, a single silicon wafer is divided into a plurality of individual silicon bases 24. Each base 24 is to ultimately become a mirror 23. In some embodiments, each mirror 23 also is manufactured to include springs and/or gimbals. At this point in the process, each base 24 is substantially flat.

The process continues to step 302, in which a material is applied to the silicon base 24 to cause it to bow either in a concave or convex manner. As known by those skilled in the art, the mirror 23 should be concave on its reflecting side. Accordingly, if the material is applied to the reflective side of the base 24, then it should have properties to cause that side of the base 24 to bow in a concave manner. Alternatively, if the material is applied to the nonreflective side of the base 24, then it should cause that side of the base 24 to bow in a convex manner.

Before it can be applied, however, properties of the material must be determined. Specifically, before applying the material, the mirror designer must select the final radius of curvature of the finished product. Specific materials thus are analyzed to determine which material is most appropriate to attain that final radius of curvature. To that end, the material properties are analyzed to determine the amount of stress the material will exert on the base 24. These stresses should cause the base molecules to either contract or expand. One property of importance thus is the physical space that the atoms of the material would take from the molecules in the silicon lattice. Accordingly, in addition to the properties of the material, the molecular structure of the base 24 also should be taken into account.

Among others, the material can include charged particles, such as ions. Exemplary ions that may be used include phosphorous, boron, and arsenic. Alternatively, elements known to cause stress, such as germanium, carbon, indium, and aluminum also may be used. Note that these materials are discussed herein as exemplary materials and not intended to limit the scope of the invention. Other materials thus may be used. In a similar manner, some embodiments are not limited to a base 24 produced from silicon. Accordingly, bases produced from other materials may be used in some embodiments.

If the material is applied from the non-reflective side of the base 24, then a material having properties that cause the reflective side to bow into a concave shape should be selected. In such case, phosphorus atoms may be used. Of course, if the material is applied from the reflective side of the base, then another material should be used. Note that this discussion is not limited to shallow ion applications. In some applications, for example, the material passes through most of the thickness of the base 24. Such a material may be a light specie with high energy, such as boron.

Various types of material initially damage the lattice of the silicon when applied. In particular, a given ion implanted within the base 24 can create mechanical stress by damaging the crystal lattice of the silicon. Different materials, however, damage the crystal lattice to different extents. Accordingly, two or more different types of material may be used on the same base 24. In particular, a first material may be used as a course tuning material to get the base 24 to a specified curvature range. After in that range, one or more other materials may be used to fine tune the curvature to very specific tolerances. For example, phosphorous causes more lattice damage and thus, causes more bowing than boron. Boron thus may be used to fine tune an initial phosphorous application.

The material may be applied to the base 24 a number of different ways. For example, the material may be applied by conventional ion implantation techniques. Alternatively, the material may be applied by conventional diffusion techniques. Yet other types of techniques may be used, such as homoepitaxy and heteroepitaxy films with suitable stress.

Additional benefits may be derived by applying the material to the base 24. For example, the conductivity of the silicon may increase. Because mirrors 23 commonly are rotated by electrostatic forces within the switch 12, increased conductivity can improve switch performance.

If the process ended at step 302, then the radius of curvature would be controlled solely by damage to the crystal lattice. In fact, if the process ended at step 302, then instead of being a mirror 23, the base 24 could be a lens because silicon transmits infrared light. Specifically, fiber optic cables 22 transmit data in infrared data signals, which generally cannot be reflected by silicon to a useful extent. Moreover, the lens would have its radius of curvature controlled merely by damage to its crystal lattice.

The base 24 may be further processed, however, by causing the damaged crystal lattice to regenerate, thereby causing the base 24 to continue to controllably bow (in either direction). The regeneration process may be referred to as “substitution.” Accordingly, the process continues to step 304, in which it is determined if it is desirable to regenerate the crystal lattice. If it is desirable, then the base 24, which at this point already has been processed by the material application, is heated to a specified temperature (step 306). In many cases, a high temperature anneal on the order of 800-900 degrees centigrade should promote satisfactory lattice regrowth. Again, in a manner similar to step 302, if the process ended, then the base 24 would be a lens and not a mirror 23.

The process then continues to step 308, in which a reflective film is added to one surface of the base 24 in accordance with conventional processes, thus ending the process. In the optical network application discussed herein, the reflective surface may be any material that effectively reflects infrared light. Among other materials, gold produces satisfactory results.

It should be noted that various steps in the discussed process can be executed at different times. For example, some material used for the reflective surface may be able to withstand high temperature anneals. Accordingly, when such materials are used, the reflective film may be added to the base 24 before the heating step. Conversely, when using a gold film, the heating step must be executed before the film is added because the maximum anneal temperature of gold is much lower than 800-900 degrees centigrade.

In a manner similar to the silicon base 24, the reflective film also has an associated coefficient of thermal expansion. Accordingly, the coefficient of thermal expansion of both the film and the base 24 should be taken into consideration when selecting the appropriate materials to apply into the silicon. In illustrative embodiments, however, the respective coefficients of thermal expansion of the base 24 and the film have a negligible effect on the final curvature of the mirror 23. Instead, the properties of the applied material provide the overriding bowing effect.

FIGS. 4A and 4B schematically show the bowing effect caused by the applied material. FIG. 4A shows the silicon base 24 just prior to material application. In such state, the silicon base 24 is substantially flat. The material is shown in FIG. 4A as being substantially evenly applied to the silicon base 24. Damage to the crystal lattice of the base 24 therefore is substantially uniform. Accordingly, as shown in FIG. 4B, the silicon base 24 bows substantially uniformly.

FIGS. 4A and 4B show the case when the silicon base 24 is damaged only. No regrowth occurs in such case. As discussed above, if heated, the silicon base 24 should begin to regrow. The regrowth process can cause the silicon base 24 to further bow in either direction, depending upon the material and silicon base properties.

In some embodiments, only selected portions of the silicon base 24 are controllably bowed. FIGS. 5A and 5B schematically show an example of such embodiments. Specifically, the material may be applied in a higher concentration in selected portions of the silicon base 24, thus causing the base 24 to bow more where more material was applied. In fact, many different portions of the silicon base 24 can have a different radius of curvature, consequently bowing in different directions. To that end, either the same or different materials may be applied to specified parts of the base 24 in varying concentrations.

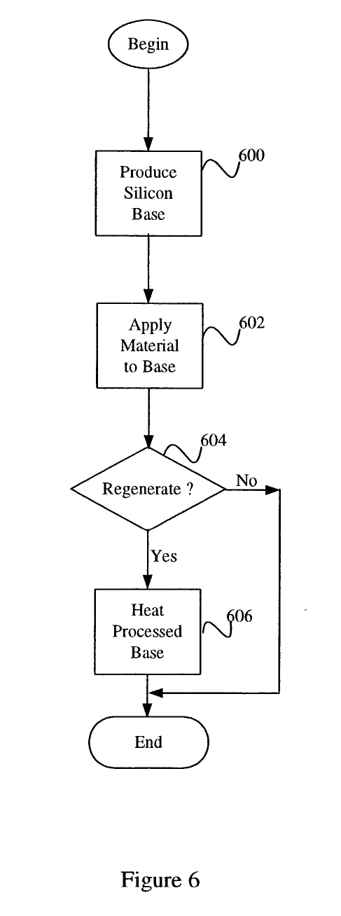

FIG. 6 shows a process of producing a lens in accordance with illustrative embodiments of the invention. This process is very similar to the process of producing a mirror 23 discussed with regard to FIG. 3, except it does not require a reflective film (step 308). In some embodiments, however, an antireflective film is added to both sides of the lens. Accordingly, in summary, the process begins at step 600, in which a silicon base 24 is produced. A material then is applied to the base 24 at step 602. It then is determined at step 604 if regenerative processes are to be used. If not, the process ends. Conversely, if regenerative processes are to be used, then the process continues to step 606, in which the processed base 24 is heated, thus ending the process. Note that many of the details discussed above with regard to the mirror 23 apply to the lens. This brief discussion of the lens thus is intended to be cursory in view of the details noted above with regard to the mirror technique.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

I claim:

1. A method of controlling the curvature of an optical device, the method comprising:
selecting a material; and
applying the material into the optical device, the material causing stress in the optical device, the curvature of the optical device changing after the material is applied, the material affecting the molecular structure of the optical device.

2. The method as defined by claim 1 wherein the optical device is at least one of a mirror and a lens.

3. The method as defined by claim 1 wherein the optical device includes a surface to receive the application, the material being applied to less than the entire area of the surface.

4. The method as defined by claim 1 wherein the material is comprised of molecules having a size, the stress being a function of the size of the molecules of the material.

5. The method as defined by claim 1 wherein the optical device comprises silicon.

6. The method as defined by claim 1 wherein the optical device includes a surface, the method further comprising:
applying a reflective layer to the surface of the optical device.

7. The method as defined by claim 1 further comprising heating the optical device to further affect the molecular structure of the optical device.

8. The method as defined by claim 1 wherein the material is one of phosphorous, boron, arsenic, germanium, carbon, indium, and aluminum.

9. The method as defined by claim 1 wherein the material is applied via at least one of a diffusion process and an implantation process.

10. A method of setting the curvature of a light distorting portion of an optical device to a given curvature, the method comprising:
selecting a material having at least one predetermined property;
providing the light distorting portion; and
applying the material to the light distorting portion based upon the at least one predetermined property of the material, the curvature of the light distorting portion changing to the given curvature after the material is applied, the material affecting the molecular structure of the light distorting portion.

11. The method as defined by claim 10 wherein the light distorting portion has a total surface area, the material being applied to less than the total surface area of the light distorting portion.

12. The method as defined by claim 10 wherein the light distorting portion is at least one of a silicon lens of a MEMS device and a silicon mirror of a MEMS device.

13. The method as defined by claim 10 wherein the material is an ion that interacts with the material of the light distorting portion to cause the curvature of the light distorting portion to change from its unapplied state.

14. The method as defined by claim 10 further comprising:
applying a reflective layer to the light distorting portion.

15. The method as defined by claim 10 further comprising:
heating the light distorting portion after the material is applied.

16. The method as defined by claim 10 wherein the material is one of phosphorous, boron, arsenic, germanium, carbon, indium, and aluminum.

17. A method of manufacturing a reflective mirror of an optical device, the reflective mirror having a given curvature, the method comprising:
providing a substantially flat silicon mirror base;
selecting a material having at least one predetermined property;
applying the material to the mirror base as a function of the at least one predetermined property of the material, the curvature of the mirror base changing to the given curvature after the material is applied, the material affecting the molecular structure of the light distorting portion; and
adding a reflective layer to one surface of the mirror base.

18. The method as defined by claim 17 further comprising heating the mirror base after the material is applied.

19. The method as defined by claim 18 wherein the reflective layer is added after the mirror base is heated.

20. The method as defined by claim 18 wherein the reflective layer is added before the mirror base is heated.
